(19) United States
(12) Patent Application Publication
(10) Pub. No.: US 2012/0100265 A1
(43) Pub. Date: Apr. 26, 2012

(54) Package for Browning and Crisping Dough-Based Foods in a Microwave Oven

(76) Inventor: Terrence P. LAFFERTY, Neenah, WI (US)

(21) Appl. No.: 13/281,738

(22) Filed: Oct. 26, 2011

Related U.S. Application Data
(63) Continuation-in-part of application No. 12/319,537, filed on Jan. 8, 2009, now Pat. No. 8,071,924.
Application No. 12/319,537 is a division of application No. 11/331,750, filed on Jan. 13, 2006, now Pat. No. 7,514,659.
(60) Provisional application No. 60/644,389, filed on Jan. 14, 2005.

(51) Int. Cl. B65D 81/34; A21D 10/02; H05B 6/80

(52) U.S. Cl. 426/107; 219/730

(57) ABSTRACT

A microwave heating construct includes a base for underlying a food item and a cover for overlying the food item. The cover may include a plurality of resilient, deformable tabs extending from an opening, where each tab includes microwave energy interactive material. The tabs may be capable of independently flexing in response to an urging force.

### CROSS-REFERENCE TO RELATED APPLICATIONS

This application is a continuation-in-part of U.S. patent application Ser. No. 12/319,537, filed Jan. 8, 2009, which is a divisional of U.S. patent application Ser. No. 11/331,750, filed Jan. 13, 2006, now U.S. Pat. No. 7,514,659, which claims the benefit of U.S. Provisional Application No. 60/644,389, filed Jan. 14, 2005, all of which are incorporated by reference herein in their entirety.

### TECHNICAL FIELD

The present invention relates to packages, constructs, and systems for heating or cooking a microwavable food item. In particular, the invention relates to various packages, constructs, and systems for heating or cooking a food item having a dough or crust in a microwave oven.

### BACKGROUND

Microwave ovens provide a convenient means for heating a variety of food items, including dough-based products such as pizzas and pies. However, microwave ovens tend to cook such items unevenly and are unable to achieve the desired balance of thorough heating and a browned, crisp crust. Additional complications are encountered with rising dough products, as the package must promote browning and crisping, typically by maintaining surface contact with the food, without restricting the natural expansion of the dough during the cooking process. Thus, there is a need for a microwave cooking package for a dough-based food item that provides the desired degree of heating, browning, and crisping without restricting the expansion of the dough.

### SUMMARY

Various packages, trays, sleeves, other constructs, and systems for heating a food item in a microwave oven are contemplated. In one aspect, a construct or system according to the present invention includes features, components, or elements that provide enhanced browning and crisping of a dough-based food item without impeding expansion of the rising dough.

In one exemplary embodiment, a microwave heating construct may include a base for underlying a food item and a dimensionally stable cover for overlying the food item. The cover may include a plurality of resilient, deformable tabs extending outwardly from an opening. The tabs may be separated from one another by slits so that the tabs are capable of independently flexing in response to an urging force applied to the tabs. Each tab may comprise microwave energy interactive material that is operative for generating heat when exposed to microwave energy. A substantially continuous portion may extend around the plurality of tabs, such that the tabs are disposed between the opening and the substantially continuous portion.

In another exemplary embodiment, a microwave heating construct may include a dimensionally stable base for underlying the food item and a dimensionally stable cover for overlying the food item. The cover may include an opening for overlying a portion of the food item not intended to be browned and/or crisped. The cover may also include a plurality of resilient, deformable tabs extending around the opening, where the tabs may comprise microwave energy interactive material for at least partially overlying a portion of the food item intended to be browned and/or crisped. The tabs are operative for independently flexing away from the opening to maintain each tab in intimate and/or proximate contact with the portion of the food item intended to be browned and/or crisped. The cover may also include a substantially continuous portion extending around the plurality of tabs, so that the tabs extend between the opening and the substantially continuous portion of the cover. The cover may further include a connector for connecting to the base to the substantially continuous portion of the cover, so that the cover can be transitioned between an open configuration and a closed configuration. Further, the tabs may be connected to the substantially continuous portion of the cover so that the tabs may be transitioned between the open configuration and the closed configuration with the substantially continuous portion of the cover.

In still another exemplary embodiment, a microwave heating construct may include a dimensionally stable base for underlying the food item and a dimensionally stable cover for overlying the food item. The cover may include an opening adapted to overlie a central portion of the food item. The cover may also include a plurality of resilient, deformable tabs extending around the opening, where the tabs may comprise microwave energy interactive material for at least partially overlying a periphery of the food item. The tabs are operative for independently flexing to maintain the tabs in intimate and/or proximate contact with the periphery of the food item. The cover also may include a substantially continuous portion extending around the plurality of tabs. The substantially continuous portion and the opening may be substantially coplanar. The substantially continuous portion may be connected to the base for being moved with the tabs and opening of the cover relative to the base between an open configuration and a closed configuration.

Any of the various constructs contemplated hereby may be used in connection with a food item having a portion intended to be browned and/or crisped, and a portion not intended to be browned and/or crisped. The cover may overlie the food item so that the opening overlies the portion of the food item not intended to be browned and/or crisped and the base underlies the food item. In an initial configuration, the tabs may be substantially coplanar with the opening, and in a second, deflected configuration, the tabs may form an acute angle with respect to the opening. In at least one of the initial configuration and the deflected configuration, the tabs substantially remain in intimate and/or proximate contact with the portion of the food item intended to be browned and/or crisped. In one specific example, the portion of the food item intended to be browned and/or crisped may comprise a rising dough, and the tabs are substantially engaged with the dough so that the tabs flex in response to the rising dough.

Countless variations of the above embodiments or numerous others are contemplated hereby. Any of such variations may be used alone or in combination with others.

For example, the substantially continuous portion of the cover may be substantially coplanar with the tabs. The substantially continuous portion of the cover may have a generally annular shape. The substantially continuous portion of the cover may be contoured so that the cover is for extending along at least one of an upper surface and a side surface of the food item. A substantially planar portion may extend around the substantially continuous portion. The substantially planar portion of the cover may be for being adjacent to the base when the cover overlies the base.

The cover may be connected to the base, so that the cover can be pivoted between an open position and a closed position with respect to the base. The cover may be pre-connected to the base, such that the base and cover are integral components of the construct, or may be provided as separate parts that are adapted to be joined to one another. The construct may also include a connector for connecting the cover to the base, where the connector is operative for allowing the cover to pivot between an open position and a closed position with respect to the base. An additional connector may be included for connecting the cover to the base, where the second connector is operative for releasably fastening the cover to the base.

The base may include microwave energy interactive material. The microwave energy interactive material may comprise a susceptor, a plurality of metal foil segments, a metal foil patch, or any combination thereof. The microwave energy interactive material may also comprise a component of a microwave energy interactive insulating material, in which the microwave energy interactive material is supported on a first polymer film, a moisture-containing layer is joined to the microwave energy interactive material, and a second polymer film is joined to the moisture-containing layer in a patterned configuration, thereby defining a plurality of expandable cells between the moisture-containing layer and the second polymer film, where the expandable cells are operative for inflating upon sufficient exposure to microwave energy.

The base may be substantially planar. Alternatively, the base may include a substantially planar bottom portion and a wall extending upwardly from a peripheral edge of the bottom portion.

Other aspects, features, and advantages of the present invention will become apparent from the following description and accompanying figures.

### BRIEF DESCRIPTION OF THE DRAWINGS

The description refers to the accompanying drawings in which like reference characters refer to like parts throughout the several views, and in which:

FIG. 1 is a cross-sectional view of an insulating microwave material that may be used according to various aspects of the present invention;

FIG. 2 is a cross-sectional view of an alternative insulating microwave material that may be used according to various aspects of the present invention;

FIG. 3 is a perspective view of the insulating microwave material of FIG. 1;

FIG. 4 depicts the insulating microwave material of FIG. 3 after exposure to microwave energy;

FIG. 5 is a cross-sectional view of yet another insulating microwave material that may be used according to various aspects of the present invention;

FIG. 6 is a cross-sectional view of still another insulating microwave material that may be used according to various aspects of the present invention;

FIG. 7 depicts an exemplary microwave cooking construct in the form of a sleeve according to various aspects of the present invention;

FIGS. 8A-8D are schematic representations of the sleeve of FIG. 7 in use;

FIG. 9 depicts another exemplary construct according to various aspects of the present invention in the form of a sleeve, where the sleeve is in an open condition;

FIG. 10 depicts the construct of FIG. 9 including a susceptor and an insulating microwave material;

FIG. 11 depicts an exemplary microwave cooking construct according to various aspects of the present invention in the form of a tray;

FIG. 12 depicts the tray of FIG. 11 in an open condition with a food item thereon;

FIG. 13 depicts the tray of FIGS. 11 and 12 in a closed condition with a food item therein;

FIG. 14 depicts another exemplary construct according to various aspects of the present invention in the form of a tray having an overall square shape;

FIG. 15 depicts another exemplary construct according to various aspects of the present invention, with an insulating microwave material on the oven-contacting surface of the base;

FIG. 16 depicts another exemplary construct according to various aspects of the present invention, with an insulating microwave material on the food-contacting surface of the base;

FIG. 17 depicts another exemplary construct according to various aspects of the present invention, with an apertured susceptor material on the food-contacting surface of the base;

FIG. 18 depicts another exemplary construct according to various aspects of the present invention, in the form of a tray for use with a thicker food item;

FIG. 19A is an exploded view of another exemplary microwave heating construct; and

FIG. 19B schematically illustrates the construct of FIG. 19A in a closed configuration.

### DETAILED DESCRIPTION

The present invention is directed generally to a cooking package, for example, a tray, sleeve, or other construct (collectively “package” or “construct” or “microwave heating construct”) for heating or cooking a food item, for example, in a microwave oven. As used herein, the terms “cooking” and “heating” shall be used interchangeably to refer to the application of heat to a food item to render it suitable or desirable for consumption by a human or animal.

In one aspect, the present invention is directed to a one-piece, integral construct for heating or cooking a food item. The various constructs may be provided in a pre-assembled configuration or may be provided as multiple components that are readily assembled into a construct having a unitary construction. The construct provides uniform heating, browning, and crisping of a dough-based food item, for example, a pizza or pastry. Unlike many two-piece systems that require the user to adjust the pieces to position the microwave active heating element properly, the construct of the present invention is easier to position the food item in and use.

The construct generally includes a base having a food-supporting or food-bearing surface on which the food item is positioned, and a cover attached to the base. The cover may include a food-exposing opening defined by an inside edge and a peripheral cover portion. The opening may be circular or any other shape as needed or desired for a particular application. The cover includes a food-contacting side or interior surface that is capable of contacting at least partially the dough portion, for example, the crust of a food item. For example, where the food item is pizza, at least a portion of the interior surface of the cover contacts the portion of the dough not covered with sauce or toppings. In the case of a pastry, such as a bottom crusted fruit pie, the periphery contacts the portion of the dough not filled with fruit or other confections. The contact may be intimate, proximate, or a combination thereof. After the food item is cooked, the outermost portion or perimeter of a dough-based food item is commonly referred to as a “crust”. However, the term “crust” is used herein to refer to the outermost portion or perimeter of the dough prior to, during, and after cooking.

Optionally, the cover includes a plurality of slits extending outwardly from the opening and normal to the inside edge of the cover. The slits form a plurality of resilient, deformable tabs that may contact intimately a substantial portion of the typically non-uniform surface of the crust. The tabs are capable of deflecting away from the base in response to a deflecting force applied thereto. Additionally, the tabs exert a downward force on the crust, thereby maintaining contact between the tabs and the crust as the dough expands and browns. Notably, the tabs do not restrict expansion of the dough. Additionally, moisture may be vented through the slits to aid in crisping. Thus, the resulting food item is similar to that obtained by cooking the food item in a conventional oven.

If desired, the base and/or cover may include or comprise one or more microwave energy interactive materials configured as one or more microwave energy interactive elements or features that alter the effect of microwave energy on the food item. Depending on the microwave energy interactive material selected, its configuration, and/or its positioning in the packaging, the microwave energy interactive element or feature may absorb microwave energy, transmit microwave energy, or reflect microwave energy, as needed or desired to suitably heat, brown, and/or crisp a particular food item. Any combination of such elements may be used.

In one example, the microwave energy interactive material may be configured as a susceptor for enhancing the heating, browning, and/or crisping of the food item. A susceptor is a thin layer of microwave energy interactive material, for example, aluminum, generally less than about 500 angstroms in thickness, for example, from about 60 to about 100 angstroms in thickness, and having an optical density of from about 0.15 to about 0.35, for example, about 0.17 to about 0.28. When exposed to microwave energy, the susceptor tends to absorb at least a portion of the microwave energy and convert it to thermal energy (i.e., heat) through resistive losses in the layer of microwave energy interactive material. The remaining microwave energy is either reflected by or transmitted through the susceptor. However, other microwave energy interactive elements may be used, as will be discussed further below.

The layer of microwave energy interactive material (i.e., the susceptor) may be deposited on or supported on a substrate, for example, a polymer film, to define a susceptor film (also sometimes simply referred to as a “susceptor”). The outermost surface (i.e., the exposed surface) of the polymer film may serve as a food-contacting surface. Other microwave energy interactive elements or features may likewise be supported on a substrate, for example, a polymer film or other electrical insulator.

In another example, the microwave energy interactive material may be configured as a foil or high optical density evaporated material having a thickness sufficient to reflect a substantial portion of impinging microwave energy. Such elements typically are formed from a conductive, reflective metal or metal alloy, for example, aluminum, copper, or stainless steel, in the form of a solid “patch” generally having a thickness of from about 0.000285 inches to about 0.005 inches, for example, from about 0.0003 inches to about 0.003 inches. Other such elements may have a thickness of from about 0.00035 inches to about 0.002 inches, for example, 0.0016 inches.

In some cases, microwave energy reflecting (or reflective) elements may be used as shielding elements where the food item is prone to scorching or drying out during heating. In other cases, smaller microwave energy reflecting elements may be used to diffuse or lessen the intensity of microwave energy. One example of a material utilizing such microwave energy reflecting elements is commercially available from Graphic Packaging International, Inc. (Marietta, Ga.) under the trade name MicroRite® packaging material. In other examples, a plurality of microwave energy reflecting elements may be arranged to form a microwave energy distributing element to direct microwave energy to specific areas of the food item. If desired, the loops may be of a length that causes microwave energy to resonate, thereby enhancing the distribution effect. Examples of microwave energy distributing elements are described in U.S. Pat. Nos. 6,204,492, 6,433,322, 6,552,315, and 6,677,563.

In still another example, the microwave energy interactive material may be configured as a susceptor that forms part of a microwave energy interactive insulating material, as will be described further below. Examples of such materials are provided in U.S. Pat. No. 7,019,271, U.S. Pat. No. 7,351,942, and U.S. Patent Application Publication No. 2008/0078759 A1, published Apr. 3, 2008.

Depending on the microwave energy interactive element or feature used, the microwave energy interactive material may comprise an electroconductive or semiconductive material, for example, a metal or a metal alloy provided as a metal foil; a vacuum deposited metal or metal alloy; or a metallic ink, an organic ink, an inorganic ink, a metallic paste, an organic paste, an inorganic paste; or any combination thereof. Examples of metals and metal alloys that may be suitable for use with the present invention include, but are not limited to, aluminum, chromium, copper, inconel alloys (nickel-chromium-molybdenum alloy with niobium), iron, magnesium, nickel, stainless steel, tin, titanium, tungsten, and any combination thereof.

While metals are inexpensive and easy to obtain in both vacuum deposited or foil forms, metals may not be suitable for every application. For example, in high vacuum deposited thickness and in foil form, metals are opaque to visible light and may not be suitable for forming a clear microwave package or component. Further, the interactive properties of such vacuum deposited metals for heating often are limited to heating for narrow ranges of heat flux and temperature. Such materials therefore may not be optimal for heating, browning, and crisping all food items. Additionally, for field management uses, metal foils and vacuum deposited coatings can be difficult to handle and design into packages, and can lead to arcing at small defects in the structure.

If desired, the microwave interactive energy material may comprise a metal oxide. Examples of metal oxides that may be suitable for use with the present invention include, but are not limited to, oxides of aluminum, iron, and tin, used in conjunction with an electrically conductive material where needed. Another example of a metal oxide that may be suitable for use with the present invention is indium tin oxide (ITO). ITO can be used as a microwave energy interactive material to provide a heating effect, a shielding effect, or a combination thereof. To form the susceptor, ITO typically is sputtered onto a clear polymer film. The sputtering process typically occurs at a lower temperature than the evaporative deposition process used for metal deposition. ITO has a more uniform crystal structure and, therefore, is clear at most coating thicknesses. Additionally, ITO can be used for either heating or field management effects. ITO also may have fewer defects than metals, thereby making thick coatings of ITO more suitable for field management than thick coatings of metals, such as aluminum.

Use of ITO in the construct of the present invention may provide additional benefits when compared with other, non-transparent microwave energy interactive materials. A clear, transparent package construction would allow the consumer to see the dough rise and brown while the food item cooks in the microwave oven. Thus, the consumer can monitor the cooking process without having to interrupt the cooking cycle. In one variation of this aspect, the susceptor is formed from ITO sputtered PET film that is laminated to a clear, low thermal shrink PET extruded sheet having a thickness of at least about 0.005 inches. The term “low thermal shrink” typically is used to refer to a material that shrinks less than about 10%, for example, less than about 2% at 350° F.

Alternatively, the microwave energy interactive material may comprise a suitable electroconductive, semiconductive, or non-conductive artificial dielectric or ferroelectric. Artificial dielectrics comprise conductive, subdivided material in a polymer or other suitable matrix or binder, and may include flakes of an electroconductive metal, for example, aluminum.

As stated above, the substrate typically comprises an electrical insulator, for example, a polymer film. The thickness of the film typically may be from about 35 gauge to about 10 mil. In one aspect, the thickness of the film is from about 40 to about 80 gauge. In another aspect, the thickness of the film is from about 45 to about 50 gauge. In still another aspect, the thickness of the film is about 48 gauge. Examples of polymer films that may be suitable include, but are not limited to, polyolefins, polyesters, polyamides, polyimides, polysulfones, polyether ketones, cellophanes, or any combination thereof. Other non-conducting substrate materials such as paper and paper laminates, metal oxides, silicates, cellulosics, or any combination thereof, also may be used. In one aspect, the polymer film comprises polyethylene terephthalate. Examples of polyethylene terephthalate films that may be suitable for use as the substrate include, but are not limited to, MELINEX®, commercially available from DuPont Teijan Films (Hopewell, Va.), and SKYROL, commercially available from SKC, Inc. (Covington, Ga.). Polyethylene terephthalate films are used in commercially available susceptors, for example, the QWIK WAVE® Focus susceptor and the MICRO-RITE® susceptor, both available from Graphic Packaging International (Marietta, Ga.).

The microwave energy interactive material may be applied to the substrate in any suitable manner, and in some instances, the microwave energy interactive material is printed on, extruded onto, sputtered onto, evaporated on, or laminated to the substrate. The microwave energy interactive material may be applied to the substrate in any pattern, and using any technique, to achieve the desired heating effect of the food item. For example, the microwave energy interactive material may be provided as a continuous or discontinuous layer or coating, circles, loops, hexagons, islands, squares, rectangles, octagons, and so forth. Examples of alternative patterns and methods that may be suitable for use with the present invention are provided in U.S. Pat. Nos. 6,765,182; 6,717,121; 6,677,563; 6,552,315; 6,455,827; 6,433,322; 6,414,290; 6,251,451; 6,204,492; 6,150,646; 6,114,679; 5,800,724; 5,759,422; 5,672,407; 5,628,921; 5,519,195; 5,424,517; 5,410,135; 5,354,973; 5,340,436; 5,266,386; 5,260,537; 5,221,419; 5,213,902; 5,117,078; 5,039,364; 4,963,424; 4,936,935; 4,890,439; 4,775,771; 4,865,921; and Re. 34,683, each of which is incorporated by reference herein in its entirety. Although particular examples of microwave energy interactive elements are shown and described herein, it should be understood that other microwave energy interactive elements and combination thereof are contemplated by the present invention.

The microwave energy interactive material and substrate may be laminated to a flexible, semi-rigid, or substantially rigid supporting material, for example, paper, paperboard, or cardboard. In one aspect, the support comprises paper generally having a basis weight of from about 15 to about 60 lbs/ream, for example, from about 20 to about 40 lbs/ream, and in one particular example, the paper has a basis weight of about 25 lbs/ream. In another aspect, the support comprises paperboard having a basis weight of from about 60 to about 330 lbs/ream, for example, from about 80 to about 140 lbs/ream. The paperboard generally may have a thickness of from about 6 to about 30 mils, for example, from about 12 to about 28 mils, and in one particular example, the paperboard has a thickness of about 12 mils. Any suitable paperboard may be used, for example, a solid bleached or solid unbleached sulfate board, such as SUS® board, commercially available from Graphic Packaging International. If needed or desired, one or more portions of the blank may be laminated to or coated with one or more different or similar sheet-like materials at selected panels or panel sections.

As stated above, in some embodiments, the microwave energy interactive material may be configured as a susceptor that forms part of a microwave energy interactive insulating material (or “insulating microwave material”. As used herein, a “microwave energy interactive insulating material” or “insulating microwave material” refers to any arrangement of layers, such as susceptor layers, polymer layers, paper layers, continuous and discontinuous adhesive layers, and patterned adhesive layers that are operative for providing an insulating effect upon sufficient exposure to microwave energy.

More particularly, the insulating microwave material may include one or more susceptor layers and one or more expandable insulating cells that inflate or expand upon sufficient exposure to microwave energy. The expandable insulating cells provide thermal insulation from the microwave heating environment so that more of the sensible heat generated by the susceptor is transferred to the surface of the food item rather than to the microwave oven environment. Without the insulating material, some or all the heat generated by the susceptor may be lost via conduction to the surrounding air and other conductive media, such as the microwave oven floor or turntable. Thus, more of the sensible heat generated by the susceptor is directed to the food item and browning and crisping is enhanced. Furthermore, insulating microwave materials may retain moisture in the food item when cooking in the microwave oven, thereby improving the texture and flavor of the food item. Examples of materials that may be suitable, alone or in combination, include, but are not limited to, are QwikWave® Susceptor packaging material, QwikWave® Focus® packaging material, Micro-Rite® packaging material, MicroFlex® Q packaging material, and QuiltWave™ Susceptor packaging material, each of which is commercially available from Graphic Packaging International, Inc. Examples of such materials are described in PCT Publication No. WO 03/066435, incorporated by reference herein in its entirety.

If desired, multiple layers of insulating microwave materials may be used to enhance the insulating properties of the construct and, therefore, browning and crisping of the food item. Where multiple layers are used, the layers may remain separate or may be joined using any suitable process or technique, for example, thermal bonding, adhesive bonding, ultrasonic bonding or welding, mechanical fastening, or any combination thereof In one example, two sheets of an insulating microwave material are arranged so that their respective susceptor layers are facing away from each other. In another example, two sheets of an insulating microwave material are arranged so that their respective susceptor layers are facing towards each other. In still another example, multiple sheets of an insulating microwave material are arranged in a like manner and superposed. In a still further example, multiple sheets of various materials are superposed in any other configuration as needed or desired for a particular application. The multi-layer material then can be used to form, or can be used in cooperation with, a construct according to the present invention. However, while such uses are described herein, it will be understood that such multi-layer insulating materials may be used independently to heat, brown, and crisp dough-based food items. Additionally, one or more layers of microwave energy interactive insulating material may be used in connection with other microwave energy interactive elements, as needed for a particular heating application.

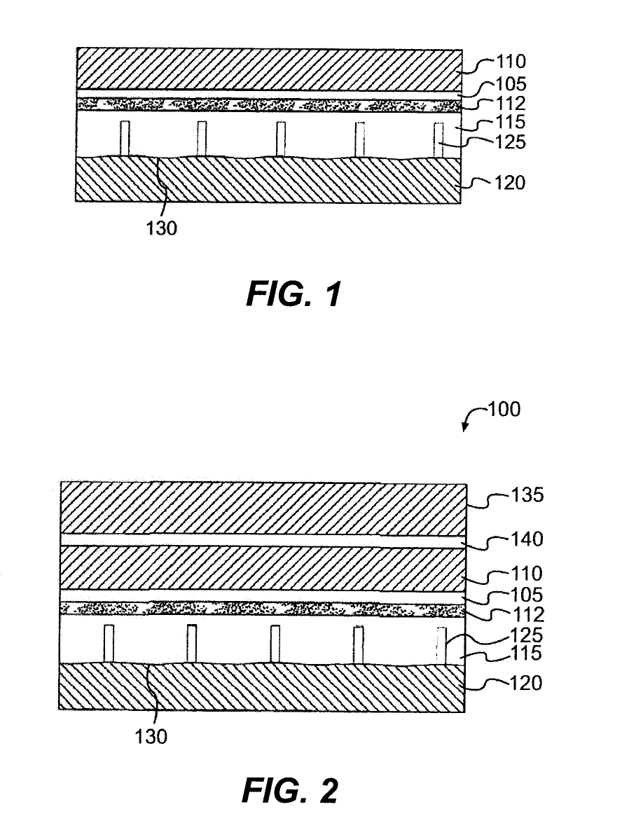

Various exemplary microwave energy interactive insulating materials are depicted in FIGS. 1-6. In each of the examples shown herein, it should be understood that the layer widths are not necessarily shown in perspective. In some instances, for example, the adhesive layers may be very thin with respect to other layers, but are nonetheless shown with some thickness for purposes of clearly illustrating the arrangement of layers.

Referring to FIG. 1, one exemplary microwave energy interactive insulating material 100 may include a thin layer of microwave interactive material 105 (i.e., a susceptor) on a first plastic (i.e., polymer) film 110 (sometimes collectively referred to as “a susceptor film”), bonded for example, by lamination with an adhesive 112, to a dimensionally stable substrate 115, for example, paper. The substrate 115 is bonded to a second plastic (i.e., polymer) film 120 using a patterned adhesive 125 or other material, such that a plurality of closed cells (i.e., expandable insulating cells) 130 are formed between the dimensionally stable substrate 115 and second polymer film 120. The closed cells 130 are substantially resistant to vapor migration.

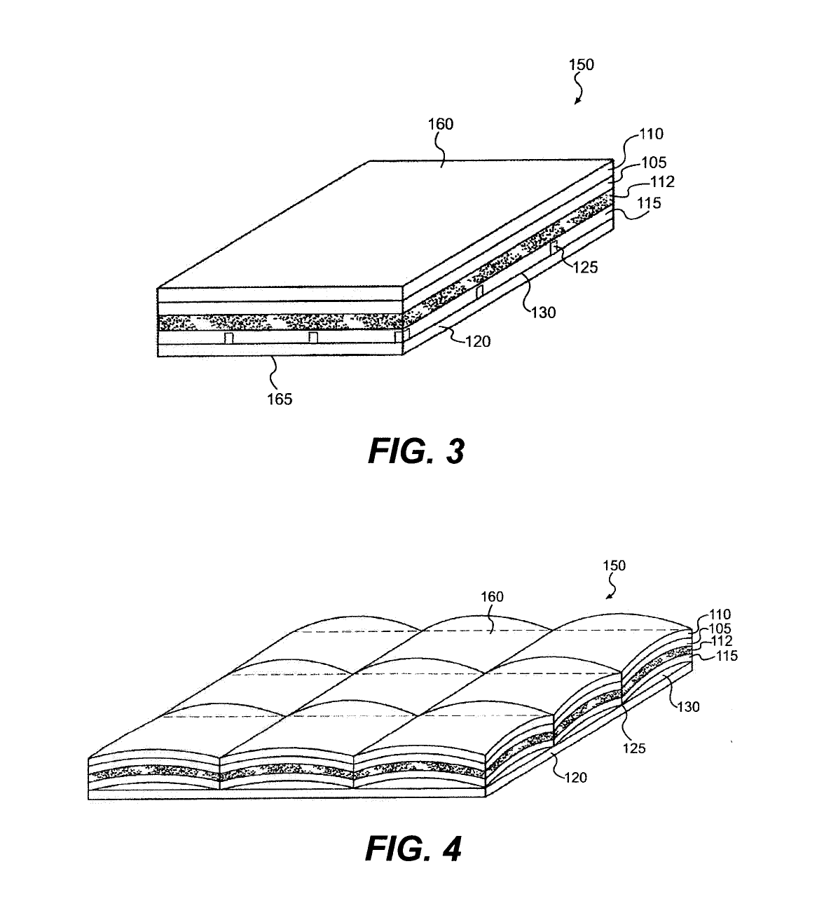

Optionally, an additional substrate layer 135 may be adhered by adhesive 140 or otherwise to the first plastic (i.e., polymer) film 110 opposite the microwave interactive material 105, as depicted in FIG. 2. The additional substrate layer 135 may be a layer of paper or any other suitable material, and may be provided to shield the food item (not shown) from any flakes of susceptor film that craze and peel away from the substrate during heating. The insulating material 100 provides a substantially flat, multi-layered sheet 150, as shown in FIG. 3.

FIG. 4 depicts the exemplary insulating material 150 of FIG. 3 after being exposed to microwave energy in a microwave oven (not shown). As the susceptor 105 heats upon impingement by microwave energy, moisture contained in the substrate 115 is converted into water vapor. The water vapor and any other gases normally held in the substrate 115, for example, paper, and any air trapped in the thin space between the second plastic (i.e., polymer) film 120 and the substrate 115 in the closed cells 130, expand. The expansion of water vapor and air in the closed cells 130 applies pressure on the susceptor film 110 and the substrate 115 on one side and the second plastic (i.e., polymer) film 120 on the other side of the closed cells 130. Each side of the material 100 forming the closed cells 130 reacts simultaneously, but uniquely, to the heating and vapor expansion. The cells 130 expand or inflate to form a quilted top surface 160 of pillows separated by channels in the susceptor film 110 and substrate 115 lamination, which lofts above a bottom surface 165 formed by the second plastic (i.e., polymer) film 120. This expansion may occur within 1 to 15 seconds in an energized microwave oven, and in some instances, may occur within 2 to 10 seconds.

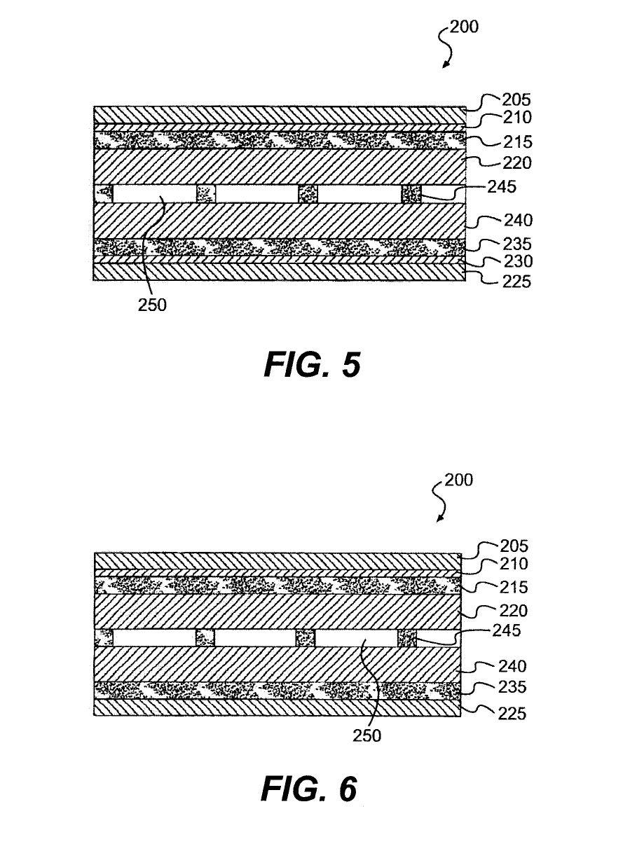

FIGS. 5 and 6 depict alternative exemplary microwave insulating material layer configurations that may be suitable for use with any of the various packages of the present invention. Referring first to FIG. 5, an insulating microwave material 200 is shown with two symmetrical layer arrangements adhered together by a patterned adhesive layer. The first symmetrical layer arrangement, beginning at the top of the drawings, comprises a PET film layer 205, a metal layer 210, an adhesive layer 215, and a paper or paperboard layer 220. The metal layer 210 may comprise a metal, such as aluminum, deposited along at least a portion of the PET film layer 205. The PET film 205 and metal layer 210 together define a susceptor. The adhesive layer 215 bonds the PET film 205 and the metal layer 210 to the paperboard layer 220.

The second symmetrical layer arrangement, beginning at the bottom of the drawings, also comprises a PET film layer 225, a metal layer 230, an adhesive layer 235, and a paper or paperboard layer 240. If desired, the two symmetrical arrangements may be formed by folding one layer arrangement onto itself. The layers of the second symmetrical layer arrangement are bonded together in a similar manner as the layers of the first symmetrical arrangement. A patterned adhesive layer 245 is provided between the two paper layers 220 and 240, and defines a pattern of closed cells 250 configured to expand when exposed to microwave energy. In one aspect, an insulating material 200 having two metal layers 210 and 230 according to the present invention generates more heat and greater cell loft.

Referring to FIG. 6, yet another insulating microwave material 200 is shown. The material 200 may include a PET film layer 205, a metal layer 210, an adhesive layer 215, and a paper layer 220. Additionally, the material 200 may include a clear PET film layer 225, an adhesive 235, and a paper layer 240. The layers are adhered or affixed by a patterned adhesive 245 defining a plurality of closed expandable cells 250.

It will be understood by those of skill in the art that in any of the packages contemplated hereby, the microwave insulating material may include an adhesive pattern that is selected to enhance cooking of a particular food item. For example, where the food item is a single item, for example, a pizza, the adhesive pattern may be selected to form substantially uniformly shaped expandable cells. Where the food item is a plurality of small items, for example, small pastries, the adhesive pattern may be selected to form a plurality of different sized cells to allow the individual items to be variably contacted on their various surfaces. While various examples are provided herein, it will be understood that numerous patterns are contemplated hereby, and the pattern selected will depend on the heating, browning, crisping, and insulating needs of the particular food item and package.

If desired, any of the numerous microwave energy interactive elements described herein or contemplated hereby may be substantially continuous, that is, without substantial breaks or interruptions, or may be discontinuous, for example, by including one or more breaks or apertures that transmit microwave energy. The breaks or apertures may extend through the entire structure, or only through one or more layers. The number, shape, size, and positioning of such breaks or apertures may vary for a particular application depending on the type of construct being formed, the food item to be heated therein or thereon, the desired degree of heating, browning, and/or crisping, whether direct exposure to microwave energy is needed or desired to attain uniform heating of the food item, the need for regulating the change in temperature of the food item through direct heating, and whether and to what extent there is a need for venting.

In the case of a susceptor, any of such discontinuities or apertures may comprise a physical aperture or void in one or more layers or materials used to form the structure or construct, or may be a non-physical “aperture”. A non-physical aperture is a microwave energy transparent area that allows microwave energy to pass through the structure without an actual void or hole cut through the structure. Such areas may be formed by simply not applying microwave energy interactive material to the particular area, by removing microwave energy interactive material from the particular area, or by mechanically deactivating the particular area (thereby rendering the area electrically discontinuous). Alternatively, the areas may be formed by chemically deactivating the microwave energy interactive material in the particular area, thereby transforming the microwave energy interactive material in the area into a substance that is transparent to microwave energy (i.e., microwave energy inactive). While both physical and non-physical apertures allow the food item to be heated directly by the microwave energy, a physical aperture also provides a venting function to allow steam or other vapors or liquid released from the food item to be carried away from the food item.

Any of the various constructs of the present invention may be coated or laminated with other materials to impart other properties, such as absorbency, repellency, opacity, color, printability, stiffness, or cushioning. For example, absorbent susceptors are described in U.S. Provisional Application No. 60/604,637, filed Aug. 25, 2004, and U.S. Patent Application Publication No. US 2006/0049190 A1, published Mar. 9, 2006, both of which are incorporated herein by reference in their entirety. Additionally, the blank or construct may include graphics or indicia printed thereon.

Optionally, one or more portions or panels of the constructs described herein or contemplated hereby may be coated with varnish, clay, or other materials, either alone or in combination. The coating may then be printed over with product, advertising, and other information or images. The constructs also may be coated to protect any information printed thereon. The constructs also may be provided with, for example, a moisture barrier layer, on either or both sides.

### EXAMPLE CONSTRUCTS

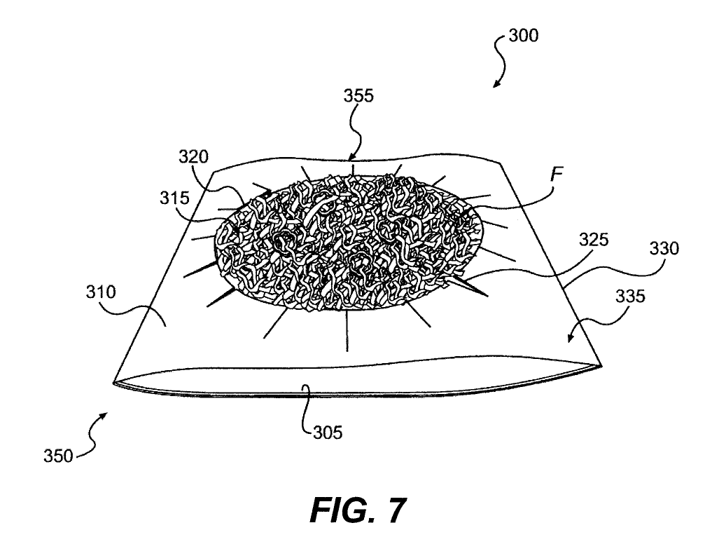

Various aspects of the invention may be illustrated further by referring to FIGS. 7-19B. For purposes of simplicity, like numerals may be used to describe like features. It will be understood that where a plurality of similar features are depicted, not all of such features are necessarily labeled on each figure.

While various exemplary embodiments are shown and described in detail herein, it also will be understood that any of the features may be used in any combination, and that such combinations are contemplated hereby. For instance, in the examples shown herein, the construct is somewhat circular or square in shape with a somewhat circular opening, suitable, for example, for heating a pizza therein. However, it will be understood that in this and other aspects of the invention described herein or contemplated hereby, numerous shapes and configurations may be used to form the various constructs. Examples of other shapes encompassed hereby include, but are not limited to, polygons, rectangles, ovals, cylinders, prisms, spheres, polyhedrons, and ellipsoids. The shape of the construct may be determined largely by the shape of the food item, and it should be understood that different packages are contemplated for different food items, for example, sandwiches, pizzas, soft pretzels, pastries, doughs, and so forth. Likewise, the constructs may include gussets, pleats, or any other feature needed or desired to accommodate a particular food item and/or portion size. Additionally, it will be understood that the present invention contemplates constructs for single-serving portions and for multiple-serving portions.

Turning to FIGS. 7-10, a cooking package in the form of a sleeve 300 is provided. The sleeve 300 includes a base 305 and a cover 310 formed from a susceptor material (e.g., susceptor film) laminated to paperboard. The cover 310 generally includes an opening 315, a substantially continuous peripheral portion 335 extending along an outside edge 330 of the cover, and a plurality of flexible tabs 340 disposed between the opening and the peripheral portion. The opening 315 is generally centrally positioned within the cover 310 and is defined or circumscribed by an inside edge 320. A plurality of slits 325 extend from the inside edge 320 toward the outside edge 330 within the peripheral portion 335 to define the plurality of tabs 340. The slits 325 may extend any distance from the inside edge 320 toward the outside edge 330 of the peripheral portion 335 of the cover 310 as needed for a given application. For example, the slits 325 may be extended where the dough is expected to expand significantly.

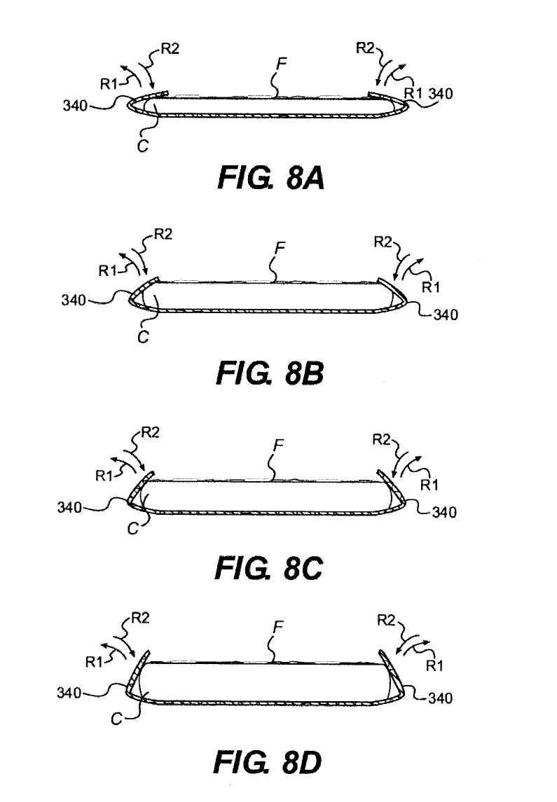

As shown in FIGS. 8A-8D, the tabs 340 overlie a portion of the food item that is intended to be browned and/or crisped (e.g., the dough or crust of a pizza). As the food item F cooks and the dough 345 rises, the tabs 340 are forced by the rising dough or crust C in an upward and outward direction R1. The tabs 340 do not restrict the natural rise of the crust C. At the same time, the memory in the paperboard causes the tabs 340 to exert a force on the dough or crust C in a direction R2. By providing tabs 340 in this manner, the crust C is in substantially continuous, substantially intimate contact with the susceptor material (i.e., the susceptor film) on the tabs 340. Additionally, any moisture in the food item may vent through the slits 325, thereby enhancing crisping of the crust C.

In the example shown in FIG. 7, the sleeve 300 includes an open first end 350 and an open second end 355 for sliding the food item F therein. In other embodiments, the second end 355 may be sealed closed.

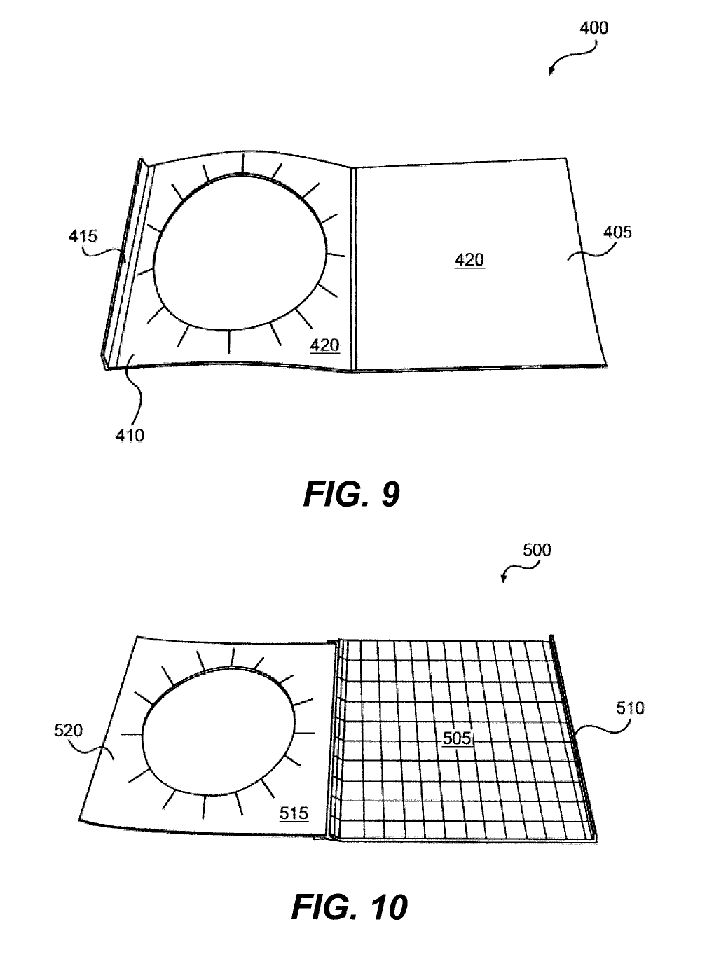

Alternatively, as shown in FIG. 9, the cooking package may be provided as an unfolded blank 400 with a base panel 405, a cover panel 410, and a flap 415. In this example, a susceptor material 420 overlies the base panel 405 and the cover panel 410. To form a sleeve (e.g., as shown in FIG. 7), the user places the food item F (not shown) on the base 405, folds the cover 410 over the food item (not shown) so that flap 415 overlaps with the base 405, and secures the cover 410 to the base 405 using a locking means, for example, a tab and slot (not shown). As shown in FIG. 10, an insulating microwave material, such as QUILTWAVE® Focus susceptor material, may be used as needed or desired for a particular heating or cooking application. In the exemplary blank 500 of FIG. 10, the insulating microwave material 505 overlies the base panel 510 and a susceptor material 515 overlies the cover panel 520.

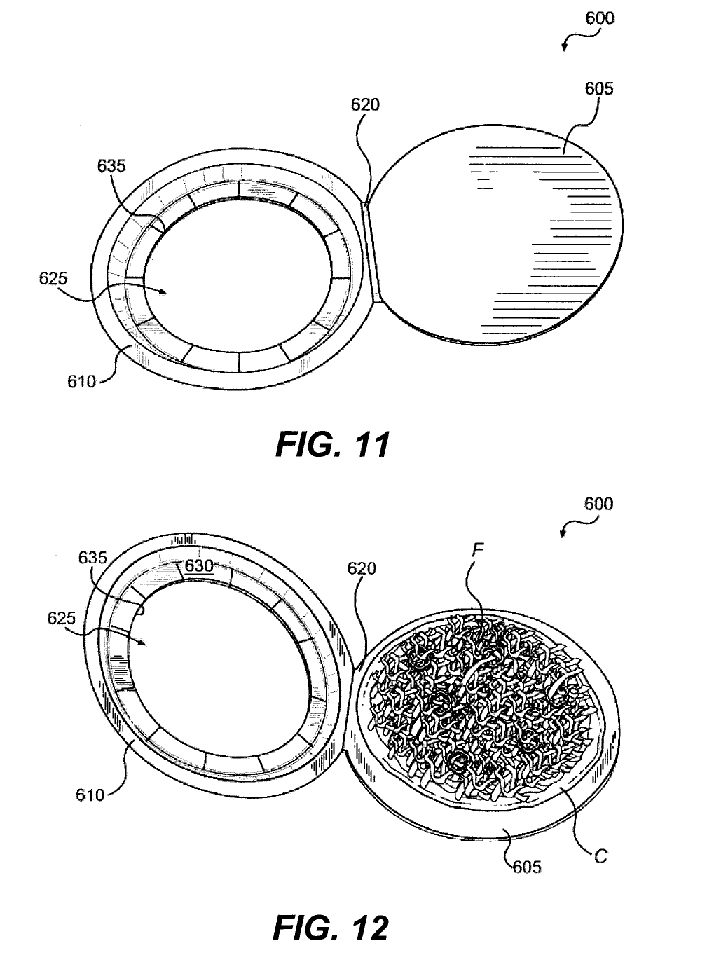

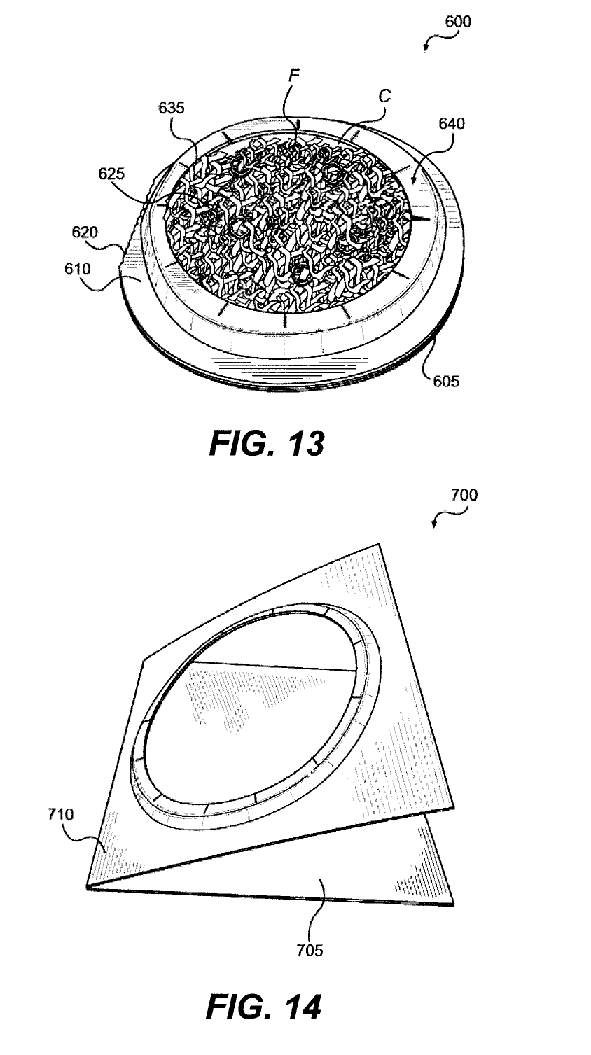

An alternate cooking package in the form of a tray 600 is provided in FIGS. 11-13. The tray 600 includes a generally circular base 605 and ring-shaped, contoured or domed cover 610 formed from a susceptor material (e.g., susceptor film) laminated to paperboard. The cover 610 may be attached hingedly to the base 605 by a fold line, perforations, flexible tape 620, or any other means that permits the cover 610 to rotate hingedly or pivot toward the base 605. The cover 610 includes a generally circular opening 625 that corresponds in size to the topped or filled portion of the food item F (best seen in FIGS. 12 and 13) and through which microwaves (not shown) directly impinge on the food item F during use. The cover 610 has a domed, three-dimensional shape having a inner surface 630 contoured to accommodate the shape of the crust C (best seen in FIG. 12), thereby allowing the susceptor material (e.g., susceptor film) on the cover 610 to be in proximate and/or intimate contact with the crust C for enhanced browning and crisping. Optionally, the cover 610 may include a plurality of slits extending outwardly from the inside edge 635 of the cover 610 toward the peripheral portion 640 that allow additional expansion of the dough as it rises.

It should be understood that while circular configurations are shown and described herein, other shaped food items and packages are contemplated by the present invention. Thus, for example, a square pizza and cooking package may be provided, and such package may include a square domed shaped cover and a square base.

FIGS. 12 and 13 depict the tray 600 during setup and use. In FIG. 11, the food item F, in this case a pizza, is placed on the base 605. The cover 610 then is brought into substantial contact with the base 605 (FIG. 13). In this configuration, the contoured portion of the cover 610 overlies the portion of the food item intended to be browned and/or crisped (e.g., the crust), and the opening 625 overlies the portion of the food item not intended to be browned and/or crisped (e.g., the toppings). If desired, a securing or locking means (not shown) may be provided to secure the cover 610 to the base 605.

Another exemplary construct 700 is provided in FIG. 14. The construct 700 includes similar features as described in connection with FIG. 11, except that the base 705 and cover 710 have an overall square shape. Other shapes are contemplated by the present invention, provided that the tray is suitably dimensioned to fit in the typical range of consumer and commercial microwave ovens and accommodate the rotation of a turntable where applicable.

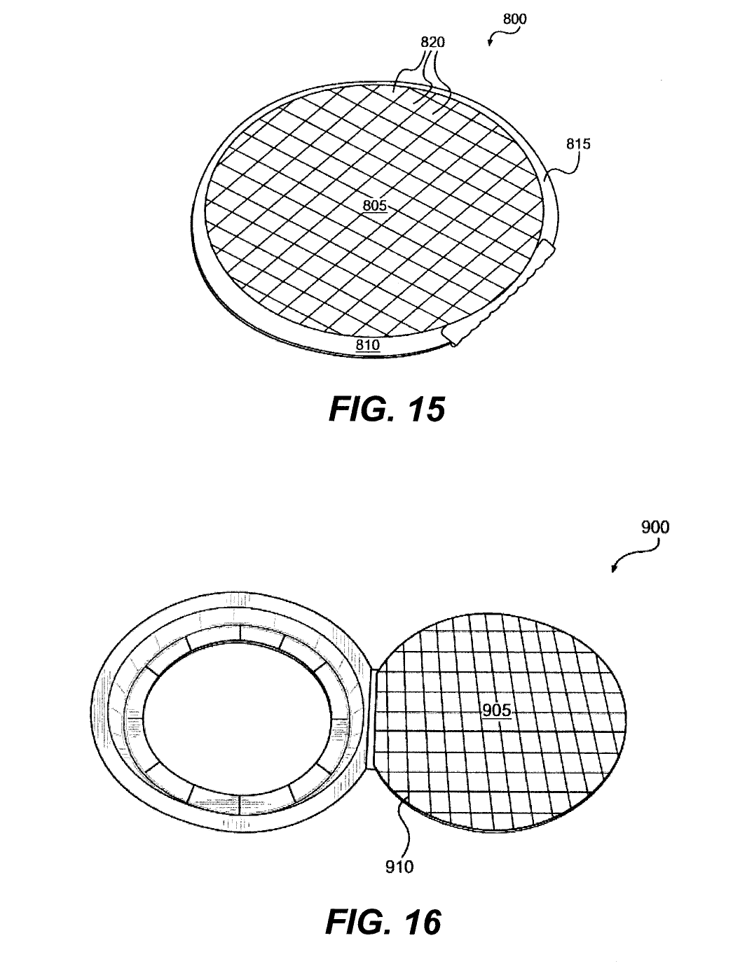

Turning to FIG. 15, yet another exemplary tray 800 is illustrated. In this example, an insulating microwave material 805 overlies at least a portion of the bottom surface 810 of the base 815. As the cells 820 inflate during cooking, the tray 800 is elevated from the bottom of the microwave or from the turntable surface (not shown). This provides insulation and minimizes susceptor heat loss to the oven floor or turntable surface. As a result, the browning and crisping of the bottom of the food item is improved. Optionally, a susceptor material or another insulating microwave material may overlie at least a portion of the opposite (food-contacting) surface of the base 810. For example, in the exemplary tray 900 shown in FIG. 16, an insulting microwave material (e.g., QUILTWAVE® Focus susceptor material) is joined to or overlies the food-contacting side of the base 910 to achieve the desired degree of browning and crisping.

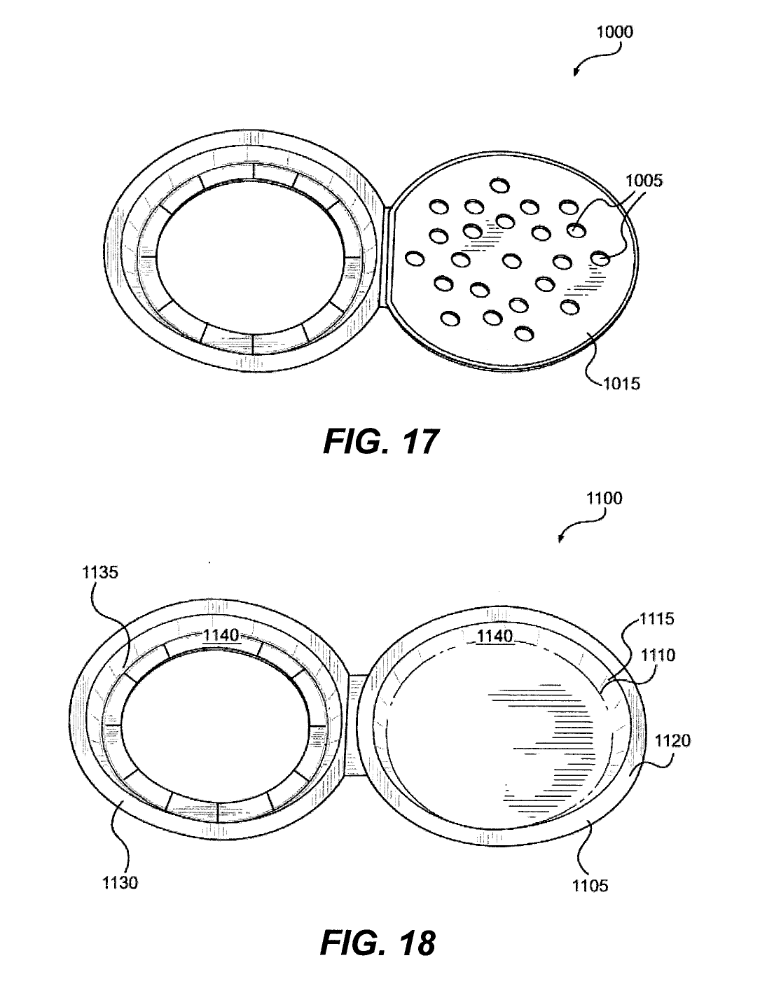

Further, in still another exemplary tray 1000 depicted in FIG. 17, one or more apertures 1005 may be provided in a susceptor material 1010 overlying the base 1015. Various patterns may be provided as needed to enhance browning and crisping, as discussed above.

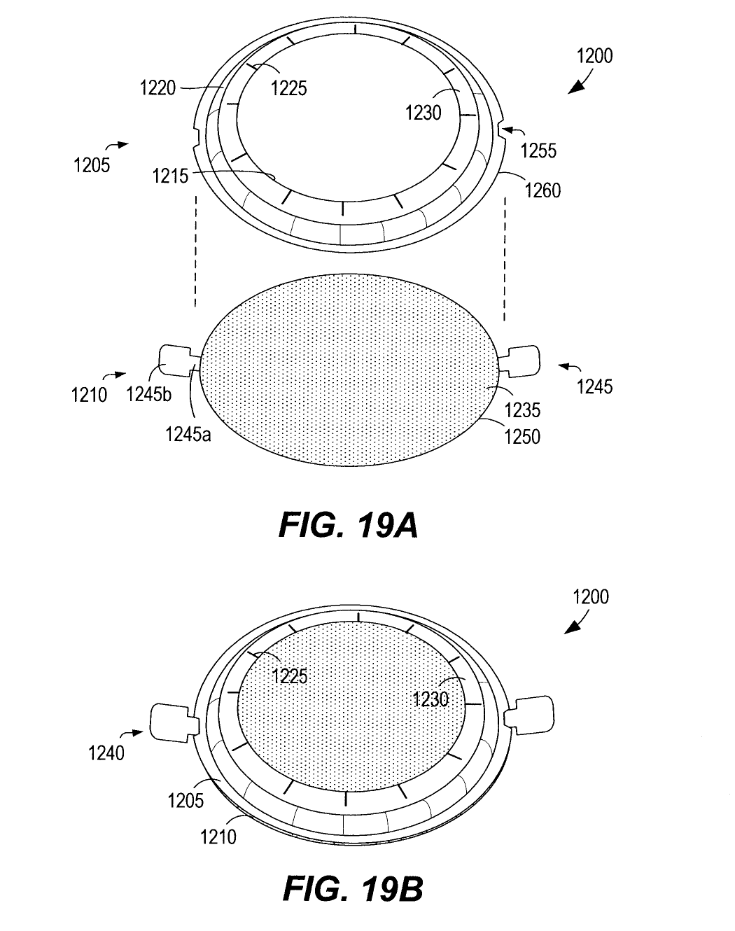

FIG. 18 depicts still another exemplary tray 1100 for a deep dish pizza or other food item (not shown) that has a greater thickness. A “deep dish” pizza typically has a crust that is from about 13 to about 16 mm in thickness near the center of the pizza and from about 26 to about 32 mm in thickness near the crust, as compared with a “thin crust” pizza, which has a crust that is from about 2 to about 5 mm in thickness near the center and from about 4 to about 7 mm in thickness near the crust. The base 1105 includes a flattened bottom portion 1110 and a wall 1115 with a flange 1120 extending therefrom. The flange 1125 is adapted to contact a corresponding flange 1130 in the domed cover 1135. A susceptor material (e.g., susceptor film) 1140 overlies the base 1105 and the cover 1135. If needed or desired, one or more apertures (not shown) may be provided in the base 1105 to permit moisture to vent from the tray.

It will be understood that the cooking package of the present invention provides numerous advantages over presently available packages. The unitary construction of the cooking package of the present invention allows a user to minimize the time required preparing the food item for cooking. It facilitates safe and convenient handling when removing hot food from the microwave oven, cutting it into portions, and serving it. Furthermore, the user is provided with a crisp, browned food item, even where a rising dough product is used.

It will be appreciated that any of the various the microwave heating constructs or packages described herein or contemplated hereby may be provided so that the base and cover are connected (i.e., integral or pre-connected) with one another. Alternatively, the microwave heating constructs or packages may be provided with the base and cover being separate components that are adapted to be connected with or joined to one another so that the base and cover become integral components of the microwave heating construct or package. Where the base and cover are provided as separate components, the base and/or cover may include one or more connectors (or connecting features) for connecting the base and cover. One or more of such features may be operative for allowing the cover to pivot between an open position and a closed position with respect to the base. Alternately or additionally, one or more of such features may be operative for releasably fastening the cover to the base. Accordingly, the embodiments illustrated schematically in FIGS. 6-18 may represent constructs in which the base and cover are provided as integral components of the construct (i.e., pre joined to one another), or may represent constructs that are provided as separate components but have been connected to one another by a connecting feature.

FIGS. 19A and 19B schematically illustrate still another exemplary microwave heating construct 1200. The microwave heating construct 1200 includes a dimensionally stable cover 1205 and a base 1210. The cover 1205 may generally have an annular, contoured shape so that the cover 1205 is for extending along the side and upper surface of a food item. The cover 1205 may include an opening 1215 and a substantially continuous peripheral portion 1220. The opening 1215 may be generally centered within the cover 1205. A plurality of cuts (e.g., slits or cutouts) 1225 may extend from the opening 1215 to the substantially continuous peripheral portion 1220. Each pair of adjacent cuts 1225 defines a flexible and/or deformable tab 1230, so that the plurality of cuts 1225 generally defines a plurality of flexible and/or deformable tabs 1230.

In this and other embodiments, the tabs 1230 may include microwave interactive material (hidden from view) operative, for example, as a susceptor for converting at least a portion of impinging microwave energy into thermal energy. The tabs 1230 may be for overlying a portion of the food item to be browned and/or crisped (e.g., a crust extending along a periphery of a pizza), and the opening may be for overlying a portion of the food item not intended to be browned and/or crisped (e.g., pizza toppings). The tabs 1230 may be substantially coplanar with the opening 1215 in a first configuration, and may flex out of the plane of the opening 1215 in a second configuration, for example, in response to an urging force exerted by a rising dough. In the second configuration, the tabs 1230 may be oblique to the substantially continuous portion of the cover 1205 and/or may form an acute angle with respect to the opening 1215.

If desired, the base 1210 may include microwave energy interactive material 1235 (shown schematically with stippling in FIGS. 19A and 19B) configured as one or more microwave energy interactive elements. For example, the microwave energy interactive material 1235 may comprise a susceptor, a plurality of metal foil segments, a metal foil patch, or any combination thereof, any of which may be supported on a polymer film that may define a food contacting surface of the base 1210. The microwave energy interactive material 1235 may alternatively or additionally comprise a component of a microwave energy interactive insulating material, in which the microwave energy interactive material 1235 (e.g., a susceptor) is supported on a first polymer film, a moisture-containing layer is joined to the microwave energy interactive material, and a second polymer film is joined to the moisture-containing layer in a patterned configuration, thereby defining a plurality of expandable cells between the moisture-containing layer and the second polymer film, where the expandable cells are operative for inflating upon sufficient exposure to microwave energy. Examples of such insulating materials are discussed above in connection with FIGS. 1-6.

It will be appreciated that any of such microwave energy interactive components may be used in any combination, as needed or desired for a particular heating application. Thus, for example, where the food item to be heated has a bottom surface that is desirably browned and/or crisped, the microwave energy interactive material 1235 of the base 1210 may include a susceptor, which optionally may comprise part of a microwave energy interactive insulating material. Where the food item to be heated has a bottom surface that is prone to overheating or over drying, the base 1210 may include a metal foil patch operative for reflecting microwave energy. Where the food item is prone to underheating within its center, the base 1210 may include metal foil segments operative for directing microwave energy towards the center of the food item. Various combinations of such features also may be used. By way of example, and not limitation, the base 1210 may include metal foil segments superposed with a susceptor, a susceptor on one side of the base 1210 and a microwave energy interactive insulating material on the other, and so on.

As shown in FIGS. 19A and 19B, the cover 1205 and/or base 1210 may include one or more features (i.e., connectors) 1240 (FIG. 19B) for joining or connecting the base and cover 1205. In the illustrated embodiment, the connector 1240 comprises a pair of locking projections or tabs 1245 that extend obliquely (outwardly and upwardly) from a peripheral edge 1250 of the base 1210 that engage a notch or cutout 1255 extending inwardly from a peripheral edge 1260 of the cover 1205. More particularly, each locking projection comprises a neck portion 1245a joined to the base and a locking portion 1245b joined to the neck portion, with the locking portion of each locking feature being wider than the neck portion. As shown in FIG. 19B, when the neck portion 1245a is inserted in the notch 1255, the wider locking portion 1245b prevents the cover 1205 from being lifted off of (i.e., separated from) the base 1210.

In this example, the construct 1200 includes two locking features. However, fewer or a greater number of locking features may be used. Further, countless other types of connectors may be used, for example, tape, clips, or any other suitable connector.

To use the microwave heating construct 1200 according to one exemplary method, a food item, for example, a pizza, may be seated on the base 1210 so that the opening 1215 overlies the portion of the food item not intended to be browned and/or crisped (i.e., the toppings) and the tabs 1230 overlie the portion of the food item intended to be browned and/or crisped (i.e., the crust). Where the cover 1205 is pre joined to the base 1210 (e.g., by inserting one locking projection 1245 into the corresponding notch 1255 or by having the cover 1205 provided as an integral component with the base 1210), the cover 1205 may be pivoted to an open position to place the food item on the base. Alternatively, where the base 1210 and cover 1205 are separate components, the cover may be placed on the base (with the food item seated thereon), and the locking feature(s) may be used to join the base and cover.

Upon sufficient exposure to microwave energy, the dough may begin to expand and exert pressure on the flexible tabs 1230, which may be urged upwardly (i.e., in a direction away from the base). Each tab 1230 may flex or deform independently so that the dough is maintained in intimate and/or proximate contact with the tabs 1230 (and so that the dough is maintained in close proximity with the microwave energy interactive material of the tabs 1230). At the same time, the microwave energy interactive material of the tabs 1230 converts at least a portion of the impinging microwave energy into thermal energy (i.e., heat), which can be transferred to the food item to brown and/or crisp the surface of the dough (e.g., to form the cooked crust). Additionally, any moisture in the food item may vent through the gaps between the tabs 1230 (e.g., along cuts 1225), thereby enhancing crisping of the crust. Likewise, any microwave energy interactive material of the base 1210 may provide browning and/or crisping, shielding, or may direct the microwave energy to particular portions of the food item, depending on how the microwave energy interactive material is configured.

When the food item is sufficiently heated, one or both connectors 1240 may be disengaged. Where one connector 1240 is disengaged, the cover 1205 may pivot between a closed position and an open position to access the food item. Alternatively, both connectors 1240 may be disengaged and the cover 1205 may be lifted from the base to access the food item.

In this and other embodiments, if desired, the cover 1205 and/or base 1210 may include one or more apertures (not shown). The aperture may comprise a physical hole that extend through the thickness of the base 1210 or cover 1205 to provide venting of any water vapor or other gases released from the food item. Alternatively, the aperture may comprise a non-physical aperture (i.e., deactivated microwave energy interactive material) that facilitates bulk heating of the food item.

It will be noted that, in this example, the cover 1205 is contoured in shape. However, it will be appreciated that other shapes may be used (such as, but not limited to those shown above) as needed to provide the desired degree of proximity between the cover and the food item (e.g., between microwave energy interactive material of the cover and the food item). Likewise, in this example, the base 1210 is substantially planar. Alternatively, the base may include a substantially planar bottom portion and a wall extending upwardly from a peripheral edge of the bottom portion (e.g., as shown in FIG. 18). Still other configurations are contemplated.

Any of the various constructs herein may be provided with an overwrap. The food item may likewise be provided with an overwrap and/or may be provided to the user seated on the base with the cover in the closed position (e.g., overlying the food item). Product information may be provided with the food item and/or may be visible through the opening in the cover.

Various aspects of the present invention may be understood further by way of the following example, which is not to be construed as limiting in any manner.

### EXAMPLE

A pizza was cooked for 5 minutes in an 1100 Watt Panasonic Model NN-S949 microwave oven. The cooked pizza was not suitably browned and crisped. The same type of pizza then was cooked for five minutes in the same microwave oven using the sleeve of FIG. 7. The crust and bottom of the pizza was suitably browned and crisp.

Although certain embodiments of this invention have been described above with a certain degree of particularity, those skilled in the art could make numerous alterations to the disclosed embodiments without departing from the spirit or scope of this invention. Any directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other.

While the present invention is described herein in detail in relation to specific aspects, it is to be understood that this detailed description is only illustrative and exemplary of the present invention and is made merely for purposes of providing a full and enabling disclosure of the present invention. It will be recognized by those skilled in the art, that various elements discussed with reference to the various embodiments may be interchanged to create entirely new embodiments coming within the scope of the present invention. It is intended that all matter contained in the above description or shown in the accompanying drawings shall be interpreted as illustrative only and not limiting. Changes in detail or structure may be made without departing from the spirit of the invention as defined in the appended claims. The detailed description set forth herein is not intended nor is to be construed to limit the present invention or otherwise to exclude any such other embodiments, adaptations, variations, modifications, and equivalent arrangements of the present invention.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

What is claimed is:

1. A microwave heating construct, comprising:
a base for underlying a food item; and
a dimensionally stable cover for overlying the food item, the cover including
a plurality of resilient, deformable tabs extending outwardly from an opening, each tab comprising microwave energy interactive material, the microwave energy interactive material being operative for generating heat when exposed to microwave energy, wherein the tabs are separated from one another by slits so that the tabs are capable of independently flexing in response to an urging force, and
a substantially continuous portion extending around the tabs, such that the tabs are disposed between the opening and the substantially continuous portion.

2. The construct of claim 1, wherein the substantially continuous portion of the cover is substantially coplanar with the tabs.

3. The construct of claim 1, wherein the substantially continuous portion of the cover has a generally annular shape.

4. The construct of claim 1, wherein the substantially continuous portion of the cover is contoured so that the cover is for extending along at least one of an upper surface and a side surface of the food item.

5. The construct of claim 4, wherein the cover further includes a substantially planar portion extending around the substantially continuous portion.

6. The construct of claim 5, wherein the substantially planar portion of the cover is for being adjacent to the base when the cover overlies the base.

7. The construct of claim 1, wherein the cover is for being connected to the base, so that the cover can be pivoted between an open position and a closed position with respect to the base.

8. The construct of claim 1, further comprising a connector for connecting the cover to the base, wherein the connector is operative for allowing the cover to pivot between an open position and a closed position with respect to the base.

9. The construct of claim 8, wherein
the connector is a first connector, and
the construct includes a second connector for connecting the cover to the base, the second connector being operative for releasably fastening the cover to the base.

10. The construct of claim 1, wherein the base comprises microwave energy interactive material.

11. The construct of claim 10, wherein the microwave energy interactive material comprises a susceptor, a plurality of metal foil segments, a metal foil patch, or any combination thereof.

12. The construct of claim 10, wherein
the microwave energy interactive material is supported on a first polymer film,
a moisture-containing layer is joined to the microwave energy interactive material, and
a second polymer film is joined to the moisture-containing layer in a patterned configuration, thereby defining a plurality of expandable cells between the moisture-containing layer and the second polymer film, wherein the expandable cells are operative for inflating upon sufficient exposure to microwave energy.

13. The construct of claim 1, wherein the base is substantially planar.

14. The construct of claim 1, wherein the base includes a substantially planar bottom portion and a wall extending upwardly from a peripheral edge of the bottom portion.

15. The construct of claim 1, in combination with the food item, wherein the food item includes a portion intended to be browned and/or crisped, and a portion not intended to be browned and/or crisped, and wherein
the cover overlies the food item so that the opening overlies the portion of the food item not intended to be browned and/or crisped, and
the base underlies the food item.

16. The construct of claim 15, wherein
in an initial configuration, the tabs are substantially coplanar with the opening, and
in a deflected configuration, the tabs form an acute angle with respect to the opening.

17. The construct of claim 16, wherein in at least one of the initial configuration and the deflected configuration, the tabs are in intimate and/or proximate contact with the portion of the food item intended to be browned and/or crisped.

18. The construct of claim 15, wherein
the portion of the food item intended to be browned and/or crisped comprises a rising dough, and
the tabs are engaged with the dough so that the tabs flex in response to the rising dough.

19. A construct for heating, browning, and/or crisping a food item in a microwave oven, comprising:
a dimensionally stable base for underlying the food item; and
a dimensionally stable cover for overlying the food item, the cover including
an opening for overlying a portion of the food item not intended to be browned and/or crisped,
a plurality of resilient, deformable tabs extending around the opening, the tabs comprising microwave energy interactive material for at least partially overlying a portion of the food item intended to be browned and/or crisped, wherein the tabs are operative for independently flexing away from the opening to maintain each tab in intimate and/or proximate contact with the portion of the food item intended to be browned and/or crisped,
a substantially continuous portion extending around the tabs, so that the tabs extend between the opening and the substantially continuous portion of the cover, and
a connector for connecting to the base to the substantially continuous portion of the cover, so that the cover can be transitioned between an open configuration and a closed configuration, wherein the tabs are connected to the substantially continuous portion of the cover so that the tabs are for being transitioned between the open configuration and the closed configuration with the substantially continuous portion of the cover.

20. A microwave heating construct, comprising:
a dimensionally stable base for underlying the food item; and
a dimensionally stable cover for overlying the food item, the cover including
an opening adapted to overlie a central portion,
a plurality of resilient, deformable tabs extending around the opening, the tabs comprising microwave energy interactive material for at least partially overlying a periphery of the food item, wherein the tabs are operative for independently flexing to maintain the tabs in intimate and/or proximate contact with the periphery of the food item, and
a substantially continuous portion extending around the plurality of tabs, the substantially continuous portion and the opening being substantially coplanar, wherein the substantially continuous portion is for being connected to the base for being moved with the tabs and opening of the cover relative to the base between an open configuration and a closed configuration.
